(19) United States
(12) Patent Application Publication
(10) Pub. No.: US 2015/0015073 A1
(43) Pub. Date: Jan. 15, 2015

(54) POWER SUPPLY CIRCUIT

(71) Applicants: HONG FU JIN PRECISION INDUSTRY (ShenZhen) CO., LTD ., Shenzhen (CN); HON HAI PRECISION INDUSTRY CO., LTD., New Taipei (TW)

(72) Inventors: KANG WU, Shenzhen (CN); BO TIAN, Shenzhen (CN)

(21) Appl. No.: 14/326,929

(22) Filed: Jul. 9, 2014

(30) Foreign Application Priority Data
Jul. 11, 2013 (CN) 2013102908030

(51) Int. Cl. H02J 9/06

(52) U.S. Cl. CPC H02J 9/061
USPC 307/64

(57) ABSTRACT

A power supply circuit includes a connector, a first power supply module, and a second power supply module. The first power supply module is connected to, and supplies power to, the connector. The second power supply module is connected to the connector and the first power supply module. The first power supply module stops supplying power to the connector and outputs a control signal to the second power supply module when a current flowing through the first power supply module exceeds a certain limit. The second power supply module supplies power to the connector when the second power supply module receives the control signal.

### FIELD

The subject matter herein generally relates to power supply circuits.

### BACKGROUND

Fans are arranged in electronic devices to dissipate heat. Power supply circuits are used to provide power to the fans.

### BRIEF DESCRIPTION OF THE DRAWINGS

Implementations of the present technology will now be described, by way of example only, with reference to the attached figures.

FIG. 1 is a block diagram of an embodiment of a power supply circuit of the present disclosure.

FIG. 2 is a circuit diagram of a connector, a first power supply module, and a second power supply module of the power supply circuit of FIG. 1.

FIG. 3 is a circuit diagram of a detection module of the power supply circuit of FIG. 1.

### DETAILED DESCRIPTION

Numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “comprising,” when utilized, means “including, but not necessarily limited to”; it specifically indicates open-ended inclusion or membership in the so-described combination, group, series and the like.

The present disclosure is described in relation to a power supply circuit 100.

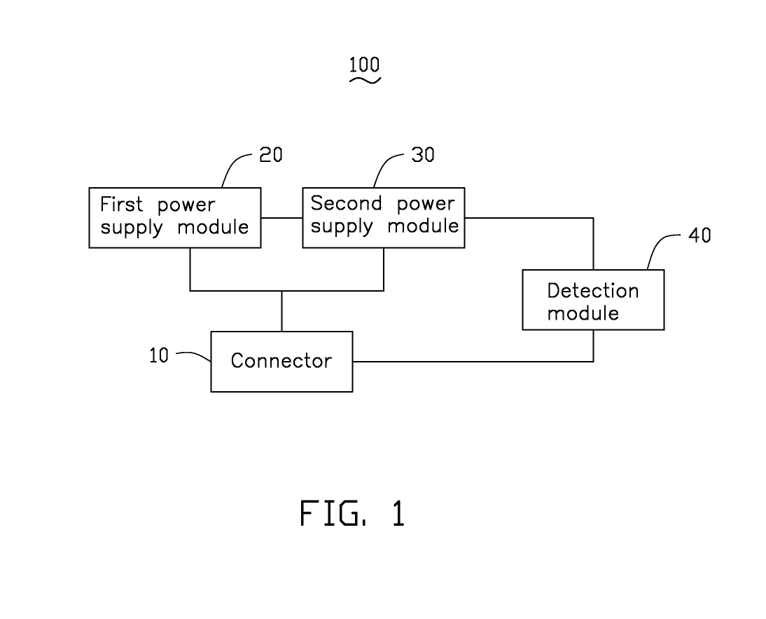

FIG. 1 illustrates the power supply circuit 100 can comprise a connector 10, a first power supply module 20, a second power supply module 30, and a detection module 40. The first power supply module 20 and the second power supply module 30 are coupled to the connector 10. The first power supply module 20 is also coupled to the second power supply module 30. The detection module 40 is coupled between the second power supply module 30 and the connector 10.

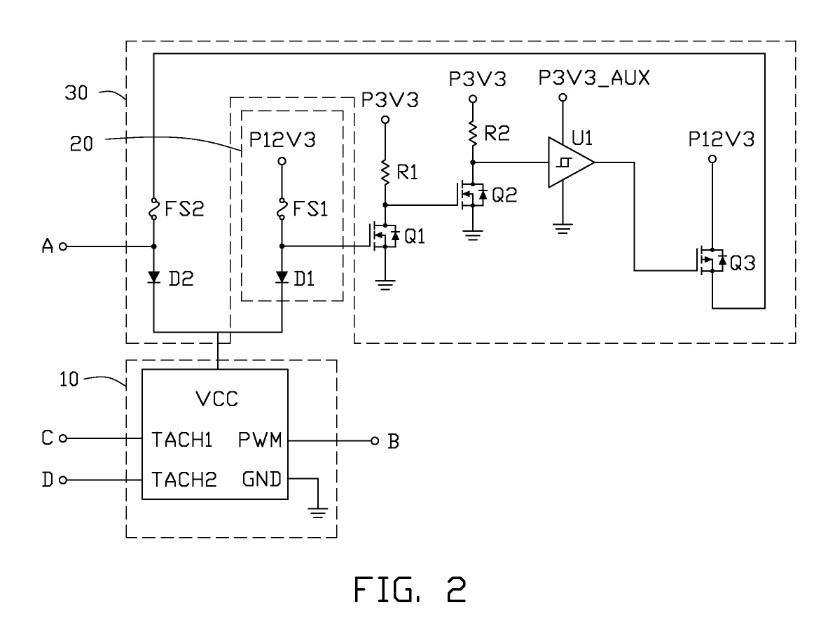

FIG. 2 illustrates an embodiment of the connector 10, the first power supply module 20, and the second power supply module 30. A power pin VCC of the connector 10 is coupled to the first power supply module 20 and the second power supply module 30. A control pin PWM, a first measuring pin TACH1, and a second measuring pin TACH2 of the connector 10 are coupled to the detection module 40. A ground pin GND of the connector 10 is coupled to ground.

The first power supply module 10 can comprise a fuse FS1, a power input terminal P12V3, and a diode D1. An anode of the diode D1 is coupled to the power input terminal P12V3 through the fuse FS1. A cathode of the diode D1 is coupled to the power pin VCC of the connector 10.

The second power supply module 20 can comprise a fuse FS2, a diode D2, three electronic switches Q1, Q2, and Q3, a trigger U1, two resistors R1, R2, a power input terminal P3V3, and a power input terminal P3V3_AUX. A control terminal of the electronic switch Q1 is coupled to the anode of the diode D1. A first terminal of the electronic switch Q1 is coupled to the power input terminal P3V3 through the resistor R1. A second terminal of the electronic switch Q1 is coupled to ground. A control terminal of the electronic switch Q2 is coupled to the first terminal of the electronic switch Q1. A first terminal of the electronic switch Q2 is coupled to the power input terminal P3V3 through the resistor R2. A second terminal of the electronic switch Q2 is coupled to ground. An input terminal of the trigger U1 is coupled to the first terminal of the electronic switch Q2. A power terminal of the trigger U1 is coupled to the power input terminal P3V3_AUX. A ground terminal of the trigger U1 is coupled to ground. A control terminal of the electronic switch Q3 is coupled to an output terminal of the trigger U1. A first terminal of the electronic switch Q3 is coupled to the power input terminal P12V3. An anode of the diode D2 is coupled to a second terminal of the electronic switch Q3 through the fuse FS2. A cathode of the diode D2 is coupled to the power pin VCC of the connector 10.

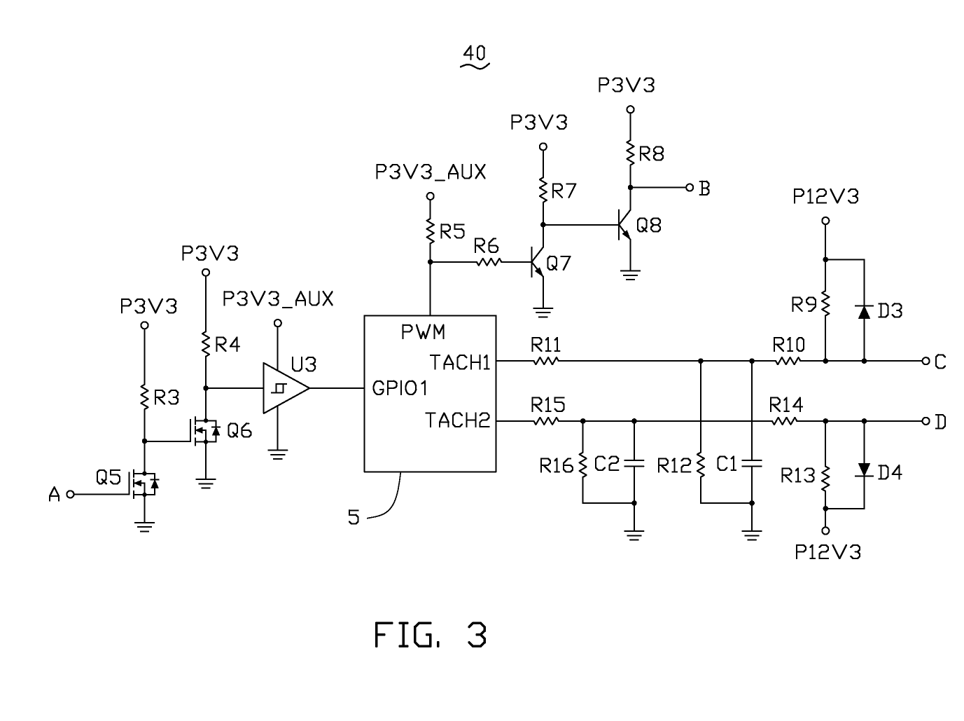

FIG. 3 illustrates an embodiment of the detection module 40. The detection module 40 can comprise four electronic switches Q5, Q6, Q7, and Q8, a trigger U3, an integrated baseboard management controller (IBMC) 5, two diodes D3, D4, two capacitors C1, C2, and fourteen resistors R3-R16. A control terminal of the electronic switch Q5 is coupled to the anode of the diode D2. A first terminal of the electronic switch Q5 is coupled to the power input terminal P3V3 through the resistor R3. A second terminal of the electronic switch Q5 is coupled to ground. A control terminal of the electronic switch Q6 is coupled to the first terminal of the electronic switch Q5. A first terminal of the electronic switch Q6 is coupled to the power input terminal P3V3 through the resistor R4. A second terminal of the electronic switch Q6 is coupled to ground. An input terminal of the trigger U3 is coupled to the first terminal of the electronic switch Q6. A power terminal of the trigger U3 is coupled to the power input terminal P3V3_AUX. A ground terminal of the trigger U3 is coupled to ground. A general purpose input output (GPIO) pin GPIO1 of the IBMC 5 is coupled to an output terminal of the trigger U3. A pulse pin PWM of the IBMC 5 is coupled to the power input terminal P3V3_AUX through the resistor R5. A control terminal of the electronic switch Q7 is coupled to the pulse pin PWM of the IBMC 5 through the resistor R6. A first terminal of the electronic switch Q7 is coupled to the power input terminal P3V3 through the resistor R7. A second terminal of the electronic switch Q7 is coupled to ground. A control terminal of the electronic switch Q8 is coupled to the first terminal of the electronic switch Q7. A first terminal of the electronic switch Q8 is coupled to the power input terminal P3V3 through the resistor R8. A second terminal of the electronic switch Q8 is coupled to ground. The first terminal of the electronic switch Q8 is also coupled to the control pin PWM of the connector 10. The first measuring pin TACH1 of the connector 10 is coupled to a first speed pin TACH1 of the IBMC 5 through the resistor R10 and the resistor R11. An anode of the diode D3 is coupled to the first measuring pin TACH1 of the connector 10. A cathode of the diode D3 is coupled to the power input terminal P12V3. The power input terminal P12V3 is also coupled to the first measuring pin TACH1 of the connector 10 through the resistor R9. A node between the resistor R10 and the resistor R11 is coupled to ground through the resistor R12 and the capacitor C1 in parallel. The second measuring pin TACH2 of the connector 10 is coupled to a second speed pin TACH2 of the IBMC 5 through the resistor R14 and the resistor R15. An anode of the diode D4 is coupled to the second measuring pin TACH2 of the connector 10. A cathode of the diode D4 is coupled to the power input terminal P12V3. The power input terminal P12V3 is also coupled to the second measuring pin TACH2 of the connector 10 through the resistor R13. A node between the resistor R14 and the resistor R15 is coupled to ground through the resistor R16 and the capacitor C2 in parallel.

In at least one embodiment, the fuse FS1 is a resettable fuse used to protect against over-current.

In operation, the power input terminal P12V3 supplies power to the power pin VCC of the connector 10 through the fuse FS1 and the diode D1. The fuse FS1 disconnects the anode of the diode D1 from the power input terminal P12V3 when a current flowing through the fuse FS1 exceeds a certain limit. No voltage is output to the control terminal of the electronic switch Q1 and the electronic switch Q1 is deactivated. The electronic switch Q2 is instantly activated and the output terminal of the trigger U1 outputs a low level signal when the input terminal of the trigger U1 receives a low level signal. The electronic switch Q3 is activated, and the power input terminal P12V3 supplies power to the power pin VCC of the connector 10 through the fuse FS2 and the diode D2.

The fuse FS1 connects the anode of the diode D1 to the power input terminal P12V3 when the current flowing through the fuse FS1 returns to a safe value. The control terminal of the electronic switch Q1 is at a high level and the electronic switch Q1 is activated. The electronic switch Q2 is instantly deactivated and the output terminal of the trigger U1 outputs a high level signal when the input terminal of the trigger U1 receives a high level signal. The electronic switch Q3 is deactivated, and no current flows through the fuse FS2 and the diode D2. The power input terminal P12V3 supplies power to the power pin VCC of the connector 10 through the fuse FS1 and the diode D1.

The electronic switch Q5 is activated when the power input terminal P12V3 supplies power to the power pin VCC of the connector 10 through the fuse FS2 and the diode D2. The electronic switch Q6 is deactivated. The input terminal of the trigger U1 receives a high level signal, and the output terminal of the trigger U1 outputs a high level signal to the GPIO pin GPIO1 of the IBMC 5. The pulse pin PWM of the IBMC 5 outputs a pulse signal to the control pin PWM of the connector 10, through the electronic switches Q7 and Q8. The first measuring pin TACH1 and a second measuring pin TACH2 of the connector 10 output speed signals of a fan installed on the connector 10 to the first speed pin TACH1 and the second speed pin TACH2 of the IBMC 5, for proving that the power supply circuit 100 is working normally.

The fuse FS2 disconnects the anode of the diode D2 from the power input terminal P12V3 when a current flowing through the fuse FS1 exceeds a certain limit. The fan on the connector 10 stops operation. The first measuring pin TACH1 and a second measuring pin TACH2 of the connector 10 stop outputting the speed signals of a fan to the first speed pin TACH1 and the second speed pin TACH2 of the IBMC 5, for proving that the power supply circuit 100 is malfunctioning. Meanwhile, no voltage is output to the control terminal of the electronic switch Q5 and the electronic switch Q5 is deactivated. The electronic switch Q6 is activated. The input terminal of the trigger U1 receives a low level signal, and the output terminal of the trigger U1 outputs a low level signal to the GPIO pin GPIO1 of the IBMC 5. The pulse pin PWM of the IBMC 5 stops outputting the pulse signal to the control pin PWM of the connector 10.

In at least one embodiment, the electronic switches Q1, Q2, Q5 and Q6 are N-channel field effect transistors, the electronic switch Q3 is a P-channel field effect transistor, and the electronic switches Q7 and Q8 are NPN bipolar junction transistors.

The embodiments shown and described above are only examples. Many details are often found in the art such as the other features of a power circuit. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including the full extent established by the broad general meaning of the terms used in the claims. It will therefore be appreciated that the embodiments described above may be modified within the scope of the claims.

What is claimed is:

1. A power supply circuit comprising:
a connector;
a first power supply coupled to the connector and configured to supply power to the connector, wherein the first power supply is configured to interrupt, when a current flowing through the first power supply exceeds a predetermined limit, the supply of power to the connector and output a control signal;
the first power supply being further configured to supply power, when the current flowing through the first power supply is below a predetermined limit, and interrupt the control signal;
a second power supply coupled to the connector and the first power supply, wherein the second power supply is configured to supply power to the connector when the second power supply receives the control signal from the first power supply and the second power supply is configured to interrupt supply of power when no control signal is received.

2. The power supply circuit of claim 1, wherein the second power supply interrupts supply of power when a current flowing through the second power supply exceeds a certain limit.

3. The power supply circuit of claim 1, wherein the first power supply comprises a first fuse, a first power input terminal, and a first diode, the first fuse is a resettable fuse, an anode of the first diode is coupled to the first power input terminal through the first fuse, a cathode of the first diode is coupled to a power pin of the connector.

4. The power supply circuit of claim 3, wherein the second power supply comprises a second fuse, a second diode, a first electronic switch, a second electronic switch, a third electronic switch, a first trigger, a first resistor, a second resistor, a second power input terminal, and a third power input terminal, a control terminal of the first electronic switch is coupled to the anode of the first diode, a first terminal of the first electronic switch is coupled to the second power input terminal through the first resistor, a second terminal of the first electronic switch is coupled to ground, a control terminal of the second electronic switch is coupled to the first terminal of the first electronic switch, a first terminal of the second electronic switch is coupled to the second power input terminal through the second resistor, a second terminal of the second electronic switch is coupled to ground, an input terminal of the first trigger is coupled to the first terminal of the second electronic switch, a power terminal of the first trigger is coupled to the third power input terminal, a ground terminal of the first trigger is coupled to ground, a control terminal of the third electronic switch is coupled to an output terminal of the first trigger, a first terminal of third the electronic switch is coupled to the first power input terminal, an anode of the second diode is coupled to a second terminal of the third electronic switch through the second fuse, and a cathode of the second diode is coupled to the power pin of the connector.

5. The power supply circuit of claim 4, wherein the first and second electronic switches are N-channel field effect transistors.

6. The power supply circuit of claim 4, wherein the third electronic switch is a P-channel field effect transistor.

7. The power supply circuit of claim 4, further comprising a detection module, wherein the detection module is coupled to a control pin, a first measuring pin, and a second measuring pin of the connector, the detection module is also coupled to the second power supply.

8. The power supply circuit of claim 7, wherein the detection module comprises a fourth electronic switch, a fifth electronic switch, a sixth electronic switch, a seventh electronic switch, a second trigger, an integrated baseboard management controller (IBMC), a third diode, a fourth diode, a first capacitor, a second capacitor, and third through sixteenth resistors, a control terminal of the fourth electronic switch is coupled to the anode of the second diode, a first terminal of the fourth electronic switch is coupled to the second power input terminal through the third resistor, a second terminal of the fourth electronic switch is coupled to ground, a control terminal of the fifth electronic switch is coupled to the first terminal of the fourth electronic switch, a first terminal of the fifth electronic switch is coupled to the second power input terminal through the fourth resistor, a second terminal of the fifth electronic switch is coupled to ground, an input terminal of the second trigger is coupled to the first terminal of the fifth electronic switch, a power terminal of the second trigger is coupled to the third power input terminal, a ground terminal of the second trigger is coupled to ground, a general purpose input output (GPIO) pin of the IBMC is coupled to an output terminal of the second trigger, a pulse pin of the IBMC is coupled to the third power input terminal through the fifth resistor, a control terminal of the sixth electronic switch is coupled to the pulse pin of the IBMC through the sixth resistor, a first terminal of the sixth electronic switch is coupled to the second power input terminal through the seventh resistor, a second terminal of the sixth electronic switch is coupled to ground, a control terminal of the seventh electronic switch is coupled to the first terminal of the sixth electronic switch, a first terminal of the seventh electronic switch is coupled to the second power input terminal through the seven resistor, a second terminal of the seventh electronic switch is coupled to ground, the first terminal of the seventh electronic switch is also coupled to the control pin of the connector, the first measuring pin of the connector is coupled to a first speed pin through the tenth resistor and the eleventh resistor, an anode of the third diode is coupled to the first measuring pin of the connector, a cathode of the third diode is coupled to the first power input terminal, the first power input terminal is also coupled to the first measuring pin of the connector through the ninth resistor, a node between the tenth resistor and the eleventh resistor is coupled to ground through the twelfth resistor and the first capacitor in parallel, the second measuring pin of the connector is coupled to a second speed pin through the fourteenth resistor and the fifteenth resistor, an anode of the fourth diode is coupled to the second measuring pin of the connector, a cathode of the fourth diode is coupled to the first power input terminal, the first power input terminal is also coupled to the second measuring pin of the connector through the thirteenth resistor, and a node between the fourteenth resistor and the fifteenth resistor is coupled to ground through the resistor sixteenth and the second capacitor in parallel.

9. The power supply circuit of claim 8, wherein the fourth and fifth electronic switches are N-channel field effect transistors.

10. The power supply circuit of claim 8, wherein the sixth and seventh electronic switches are NPN bipolar junction transistors.
